(19) United States
(12) Patent Application Publication
(10) Pub. No.: US 2009/0138377 A1
(43) Pub. Date: May 28, 2009

(54) Clothes fitting service method of providing information about fitting of clothes

(76) Inventors: Uk OH, Seoul (KR); Jae Chul KIM, Seoul (KR); Du Hwan YEO, Seoul (KR); Jin Young LEE, Seoul (KR); Jeong Wook SUH, Seoul (KR); In Chul KANG, Seoul (KR)

Correspondence Address: BIRCH STEWART KOLASCH & BIRCH, PO BOX 747, FALLS CHURCH, VA, 22040-0747, US

(21) Appl. No.: 11/987,098

(22) Filed: Nov. 27, 2007

(51) Int. Cl. G06Q 30/00

(52) U.S. Cl. 705/27

(57) ABSTRACT

Disclosed herein is a method of providing a clothes fitting service to a plurality of clients having respective terminals. The terminals are capable of accessing a network via a wireless or wired connection. In the method, body information is received via the network, a 3D user avatar corresponding to a client is created based on the body information, the client selects specific clothes, and the 3D user avatar is provided with the selected specific clothes on. Thereafter, when the specific clothes are put on the 3D user avatar, information about fitting of the clothes is calculated, and the calculated information about fitting of the clothes is provided to the client.

### BACKGROUND OF THE INVENTION

1. Field of the Invention

The present invention relates generally to a business technique for providing clothes-related services via a network and, more particularly, to a clothes fitting service method of providing information about the fitting of clothes to a plurality of clients.

2. Description of the Related Art

Recently, with the development of communications and network technology, Internet business techniques for setting up virtual shopping malls (that is, shopping mall web sites) on the Internet and dealing in various types of products (for example, cars, various types of electronic products, office equipment, digital books, and various types of clothes) online have been continuously developed and have provided services.

Products on sale are displayed in virtual space in such web sites, users (that is, clients) access corresponding web sites via the Internet and purchase desired goods (or products), and payment for online purchases are made using various methods, such as electronic money payment, credit card payment, and deposit without a bank account. In this case, the products purchased by the clients are generally delivered to the corresponding clients through home-delivery service providers who specialize in delivery.

Meanwhile, web sites (clothes sales web sites) that are selling clothes online via the Internet have been set up and have provided services. Such web sites provide a service of displaying photos of actual clothes on sale in various fashions, or a service of enabling users to put clothes on avatars, which are the manifestation of the users.

However, the conventional online clothes business technique for providing the service of displaying the photos of actual clothes or enabling users (the users of a clothes fitting service) to put clothes on avatars, which are the manifestation of the users, has limitations in meeting the users' various demands.

Accordingly, in the actual circumstances in which users' demand for services becomes diversified and complicated, if a service of enabling a user to determine whether clothes that the user desires to purchase online fit the user's own body characteristics, that is, a service of enabling the user to determine whether the space between the user's body and clothes is appropriate, whether the degree of contact of clothes with the user's body is appropriate, and how much clothes that is put on the user can be expanded, when the user actually puts on the corresponding clothes, is provided, users' various demands for services can be met and the improvement of competitive power can be also attempted through differentiation of a service. However, there are no proposals for such a business technique.

### SUMMARY OF THE INVENTION

Accordingly, the present invention has been made keeping in mind the above problems occurring in the prior art, and an object of the present invention is to provide a clothes business method of providing information about the fitting of clothes occurring when the selected clothes is put on a 3D avatar that is created using the body information of a service member.

In order to accomplish the above object, the present invention provides a method of providing a clothes fitting service to a plurality of clients having respective terminals, the terminals being capable of accessing a network via a wireless or wired connection, the method including receiving body information via the network, and creating a 3D user avatar corresponding to a client based on the body information; allowing the client to select specific clothes; providing the 3D user avatar with the selected specific clothes on; and when the specific clothes is put on the 3D user avatar, calculating information about fitting of the clothes, and providing the calculated information about fitting of the clothes to the client.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing a system for providing a clothes fitting service in which the present invention is directly applied to the Product Placement (PPL) technique;

FIG. 2 is a flowchart showing a procedure of registering as a service member to receive a clothes fitting service in which the present invention is applied to the PPL technique;

FIG. 3 is a flowchart showing a procedure of providing a clothes fitting service to clients through the application of the present invention to the PPL technique;

FIG. 4 is a flowchart showing a procedure that is carried out after the determination of a purchase by a client through the application of the present invention to the PPL technique;

FIG. 5 is a view showing examples of virtual screens that are provided through a preview function when clothes are put on a 3D avatar according to the present invention;

FIG. 6 is a diagram showing an example of calculating the deformation ratio when clothes are put on a 3D avatar according to the present invention;

FIG. 7 is a view showing an example in which a fabric is modeled as a collection of triangles and the deformation ratio of each vertex is calculated;

FIG. 8 is a diagram showing an example of calculating the clothes pressure when clothes are put on a 3D avatar according to the present invention; and

FIG. 9 is a diagram showing an example of calculating the amount of space when clothes are put on a 3D avatar according to the present invention.

### DESCRIPTION OF THE PREFERRED EMBODIMENTS

Reference now should be made to the drawings, in which the same reference numerals are used throughout the different drawings to designate the same or similar components.

Preferred embodiments of the present invention will be described in detail below with reference to the accompanying drawings.

The technical gist of the present invention resides in the provision of a clothes fitting service of creating a three-dimensional (3D) avatar suitable for the body characteristics of each user based on body information registered as the member information of the service member, calculating information about the fitting of clothes, such as the deformation ratio, the clothes pressure and the amount of space, when the clothes selected by the service member is put on his or her 3D avatar, and selectively providing the calculated information about the fitting of clothes to the service member.

Here, the deformation ratio indicates the degree of expansion of desired clothes when the clothes are put on the 3D avatar of a corresponding service member, the clothes pressure indicates the degree of contact with a 3D avatar when desired clothes are put on the 3D avatar of a corresponding service member, and the amount of space indicates the space between the body of a 3D avatar and desired clothes when the clothes are put on the 3D avatar suitable for the actual body characteristics of the corresponding service member online.

Furthermore, the body information of each service member may be, for example, the body size information and hairstyle information of the corresponding service member, which are acquired through a 3D scanner. Alternatively, the body information may be information that is selected by a corresponding service member from among a plurality of gender-based representative body shapes, model faces, model bodies, and model hairstyles, which were previously prepared.

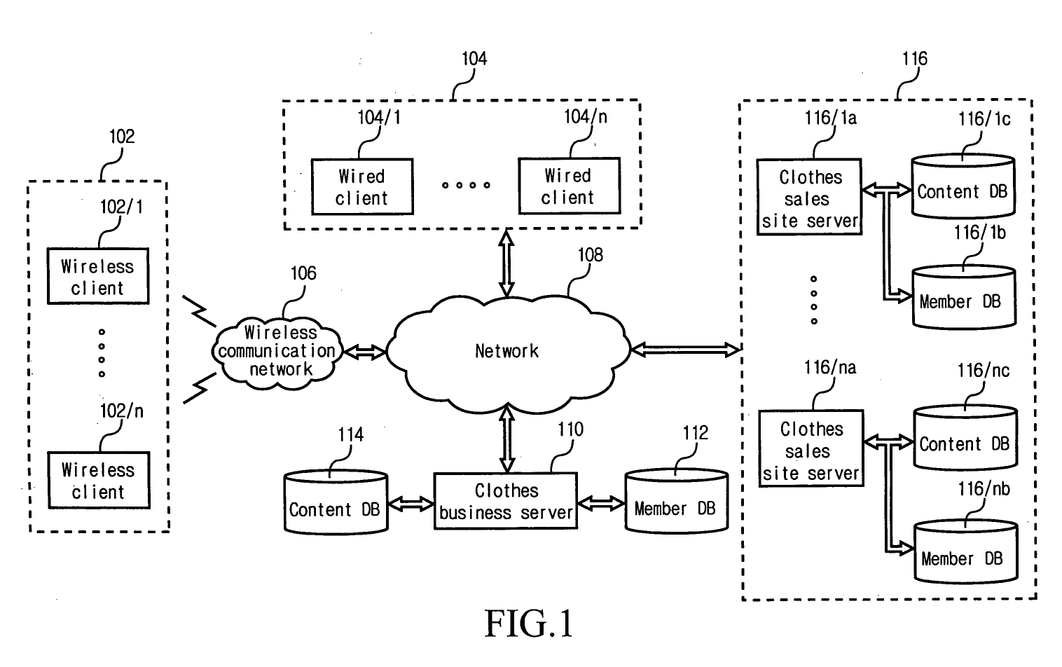

FIG. 1 is a block diagram showing a system for providing a clothes fitting service in which the present invention is directly applied to the PPL technique.

The present invention includes a wireless client group 102 composed of a plurality of wireless clients 102/1-102/n, a wired client group 104 composed of a plurality of wired client 104/1-104/n, a wireless communication network 106, a network 108, a clothes business server 110, a member DB 112, a content DB 114, and a clothes sales site server group 116 composed of a plurality of clothes sales site servers 116/1a-116/na each including one of member DBs 116/1b-116/nb and one of content DBs 116/1c-116/nc.

Referring to FIG. 1, respective wireless clients 102/1-102/n of the wireless client group 102 are mobile communication terminals (for example, PCS phones, cellular phones, PDAs, IMT-2000 terminals, DMB phones, or PMPs) that can access the clothes business server 110 via the communication network 106, including a plurality of Base station Transceiver Systems (BTSs) and Base Station Controllers (BSCs), a Mobile Switching Center (MSC) and a Wireless Application Protocol (WAP) gateway, and via the wireless network 108.

Each of the wireless clients selectively registers with a desired clothes sales site server and the clothes business server 110 as service members, and receives a clothes-related or purchase service suitable for his or her body size through a clothes fitting service, for example, a clothes fitting service using the PPL technique.

Here, personal information, body information, clothes preference information, and purchase history information are selectively used for member information required for the registration as service members as occasion requires.

The personal information includes information, such as a name, a gender, a resident registration number, a mobile communication terminal number, a mail address, and a residence address.

The body information may be, for example, one's own body size information and hairstyle information acquired through a 3D scanner, or actual photo information. Alternatively, the body information may be information that is selected by a corresponding service member from among a plurality of gender-based representative body shapes, model faces, model bodies, and model hairstyles, which were previously prepared. Such body information may be the member information of a member (a client) who has registered with a desired clothes sales site server, or the member information of a member (a client) who has registered as the service member of the clothes business server.

The clothes preference information is information about a color or style that is preferred by each service member.

The purchase history information is information that is formed by accumulating information about clothes that have been purchased by each service member in the past, and includes information about the sizes, colors and styles of clothes that have been purchased by the service member.

Now, when a menu screen related to a program genre (for example, a movie, a drama, sports, comics, and an advertisement) is provided from the clothes business server 110, each of the wireless clients selects a desired program genre. Thereafter, when corresponding poster information is provided from the clothes business server 110 in response to the selection, the wireless client selects desired clothes from the poster.

By putting desired clothes on his or her 3D avatar when clothes information such as a still image or a moving image, and a 3D avatar fabricated and created to be suitable for his or her body characteristics, are provided from the clothes business server 110 in response to the selection of clothes, information about the fitting of clothes (or the adaptability of clothes), including the deformation ratio, the clothes pressure, and the amount of space, can be provided from the clothes business server 110.

Furthermore, in the process in which each wireless client receives the body characteristics-adaptive 3D avatar-based clothes fitting service using a PPL technique and body information as described above, the wireless client can receive a desired clothes purchase service. Such a clothes purchase service may be provided through the clothes business server 110 or a clothes sales site server selected by the wireless client.

Respective wired clients 104/1-104/n of the wired client group 104 are, for example, Personal Computer (PC) systems that can access the network 108 via a dedicated line, an ADSL, a modem, etc. Respective wired clients 104/1-104/n access the clothes sales site servers 116/1a-116/na or the clothes business server 110 via the network 108, and are provided with substantially the same service as the above-described wireless clients 102/1-102/n.

Meanwhile, respective clothes sales site servers 116/1a-116/na of the clothes sales site server group 116 are web sites that provide a clothes service of providing or selling clothes-related products online to the wireless or wired clients.

For this purpose, the above-described personal information, body information, clothes purchase history information and clothes preference information of respective members are selectively stored in respective member DBs 116/1b-116/nb as the member information of the wireless or wired clients who have registered as members.

Furthermore, clothes-related content (for example, the clothes information of respective pieces of clothes that are put on participants in a PLL advertisement) to be provided to respective registered members is stored in respective content DBs 116/1c-116nc. Here, the clothes information includes, for example, still image and moving image information, or the like.

The clothes business server 110 provides the present invention-based clothes fitting service to a plurality of wireless or wired clients while selectively operating in conjunction with respective clothes sales site servers 116/1a-116/na.

In more detail, the clothes business server 110 provides a service of providing a genre menu screen, including information about a program genre (for example, a movie, a drama, sports, comics, and an advertisement), providing the poster information of a selected program genre in response to a user's selection, providing clothes information such as a still image or a moving image, and a 3D avatar fabricated to be suitable for the actual body characteristics (that is, body information) of the corresponding user in response to the user's selection of clothes, or selectively providing a clothes purchase service to the desired client who wands a clothes fitting service.

In this case, the clothes business server 110 stores the poster information of respective program genres therein. The clothes business server 110 may store clothes information in the content DB 114, or may receive clothes information from a corresponding clothes sales site and temporarily store it in the content DB 114.

For this purpose, clothes-related content, that is, program genre-based poster information, received from respective clothes sales site servers 116/1a-116/na, is stored in the content DB 114. Additionally, a clothes information list and respective pieces of clothes information corresponding to each piece of poster information are selectively stored. Furthermore, the member information (body information, personal information, purchase history information, and clothes preference information) of respective members, which have registered with the clothes business server 110 as service members, may be classified according to the clothes sales site server and be stored in the member DB 112.

Furthermore, the clothes business server 110 provides a function of creating a 3D avatar suitable for the body characteristics of a corresponding client based on body information that is provided or that is selected and provided when the client registers as a service member, and a function of storing the 3D avatar as member information.

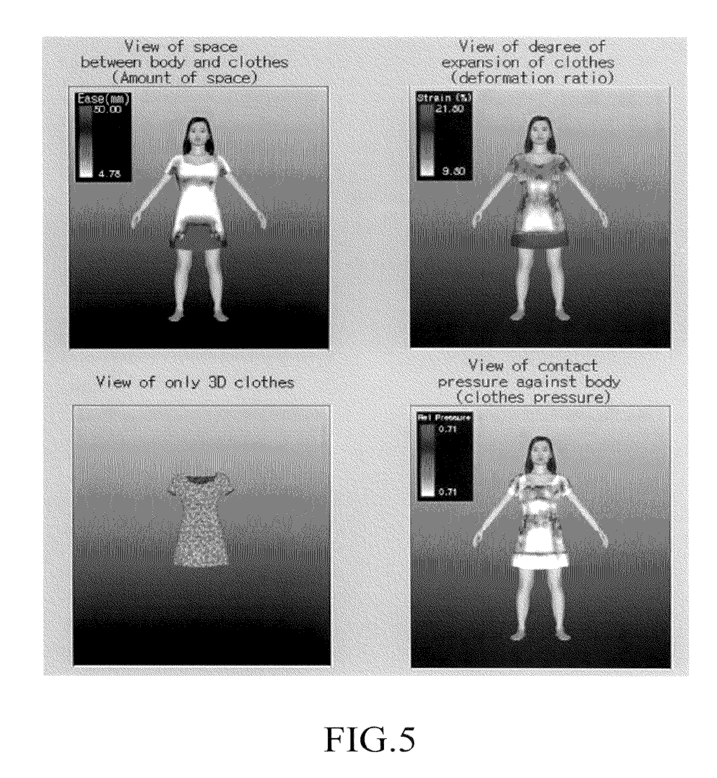

Moreover, the clothes business server 110 provides a function of calculating deformation ratio information, indicating the degree of expansion of clothes, clothes pressure information, indicating the degree of contact of clothes with a 3D avatar, and the amount of space information, indicating the space between the body of a 3D avatar and clothes, when a client who has registered as a service member puts desired clothes on a 3D avatar while the client is receiving a clothes fitting service. In this case, the calculated information about the fitting of clothes (that is, the deformation ratio, the clothes pressure, and the amount of space) is provided to a corresponding client in response to the selective request of the corresponding client using a preview function, as shown in FIG. 5 as an example.

Generally, whether desired clothes fit well when the clothes are put on the 3D avatar of a service member is determined based on the amounts of space, indicating the space between respective portions of the clothes and respective portions of the avatar.

Meanwhile, in the case of clothes, such as jeans, which have low elasticity and come into tight contact with a body, when clothes having a plurality of sizes around a size suitable for a service member are put on an avatar, they all come into tight contact with the avatar, and thus exhibit almost no amount of space. Therefore, it is difficult to determine whether such clothes fit the service member well using the amount of space, so that it is preferable to select clothes having an appropriate clothes pressure by determining whether the clothes fit the service member well using clothes pressure that is exerted on the clothes when the clothes come into tight contact with a body.

Furthermore, in the case of clothes, such as tights or sweaters, which has high elasticity and come into tight contact with bodies, clothes having a plurality of sizes around a size suitable for a service member are put on his or her avatar, they all come into tight contact with the avatar and exhibit almost no amount of space. Therefore, it is difficult to determine whether such clothes fit the service member well using the amount of space, so that it is preferable to select clothes having an appropriate deformation ratio by determining whether the clothes fit the service member well using the deformation ratio that indicates the degree of deformation of the clothes when the clothes come into tight contact with a body.

That is, it is preferred that the fitting of clothes information, formed by appropriately selecting or combining the amount of space, the clothes pressure and the deformation ratio according to clothes, be provided to service members.

Now, a method of calculating the amount of space, clothes pressure, and deformation ratio will be described below.

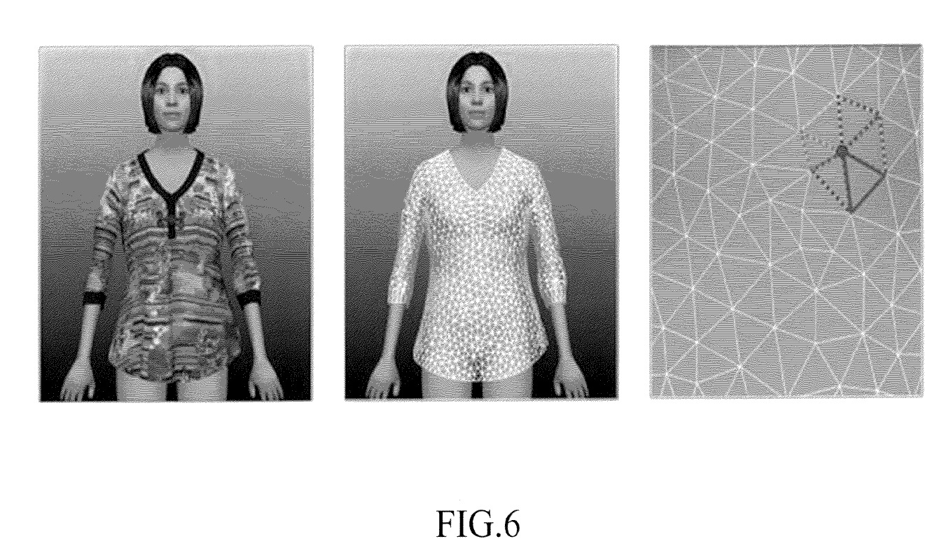

As shown in FIG. 6, when a fabric is modeled as a collection of triangles, each point of a triangle, which makes surface contact, is shared by a plurality of triangles. In consideration of this, the percentage of variation in the area of each triangle can be calculated through the calculation of the deformation ratio n of each triangle using the following Equation 1:

$$n = \frac{L 1}{L} \times 100 \qquad ( 1 )$$

where L indicates the original area of a triangle and L1 indicates the area obtained after the modeling of the triangle.

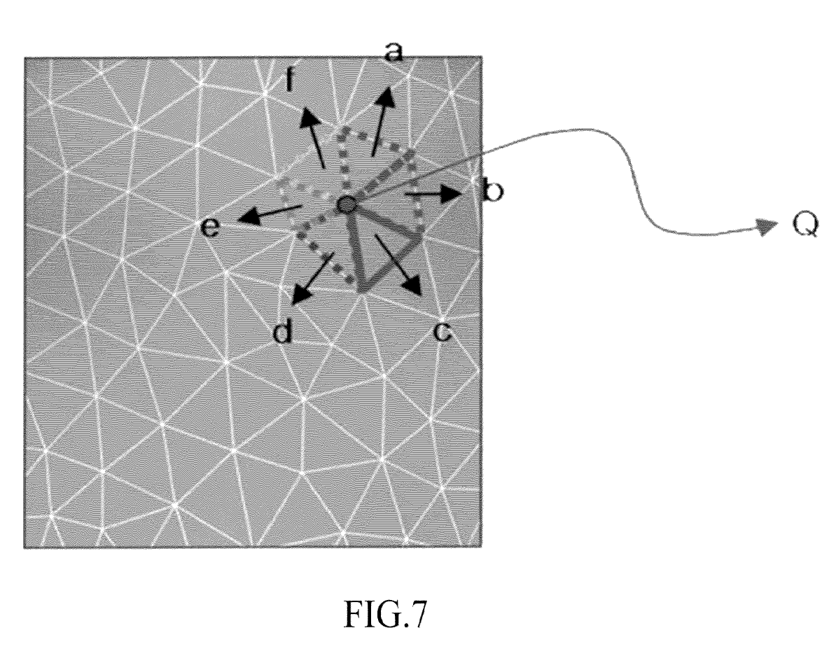

Accordingly, the average of the deformation ratios of triangles associated with each vertex can be considered as the deformation ratio of the vertex. Assuming that triangles that come into contact with each other at a vertex Q are a, b, c, d, e, and f, as shown in FIG. 7 as an example, the deformation ratio q of each vertex can be calculated using the following Equation 2:

$$q = \frac{{a}^{′} + {b}^{′} + {c}^{′} + {d}^{′} + {e}^{′} + {f}^{′}}{p} \times 100 \qquad ( 2 )$$

where a′, b′, c′, d′, e′, and f′ indicate respective deformation ratios of triangles a, b, c, d, e, and f, and p indicates the number of triangles that come into contact with each other at the vertex Q.

Accordingly, the clothes business server 110 can calculate deformation ratio that indicates the degree of expansion of clothes when the clothes are put on a 3D avatar through the above-described series of processes.

The clothes business server 110 may display partial variation in color based on the deformation ratios of clothes, for example, in such a way as to perform display such that the tone of a red color increases as the deformation ratio increases, the tone of a blue color increases as the deformation ratio decreases, and a white color is displayed when there is no deformation ratio, with the result that the user of a corresponding client who receives a clothes fitting service can visually perceived the deformation ratios of the clothes.

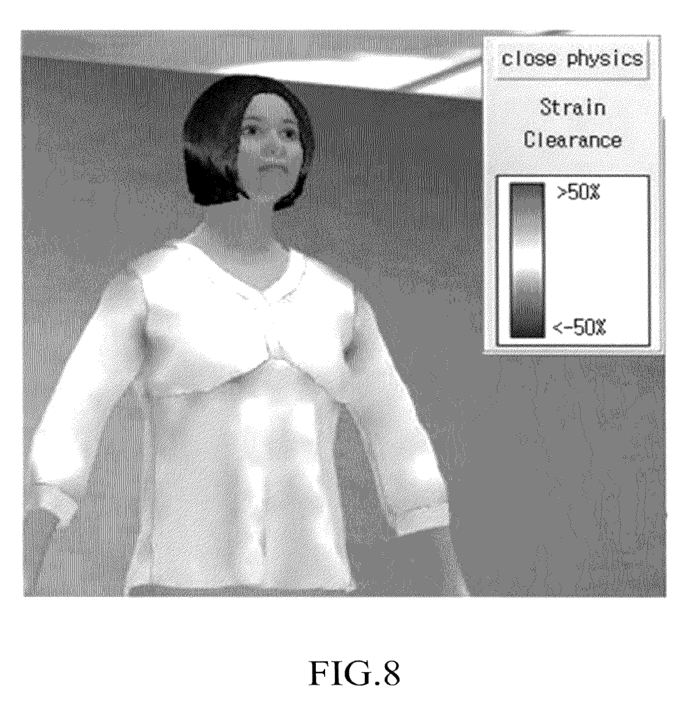

Furthermore, the clothes business server 110 calculates stress through reverse operation based on a strain value in consideration of the physical property values of an original fabric, and calculates clothes pressure using a technique, such as a technique of performing modeling using a linear algebraic expression on the assumption that strain is minute or a technique of performing modeling using a non-linear algebraic expression based on characteristics, which is well known in the related field. The calculated clothes pressure is represented using partial variation in the color of clothes (for example, a change from a red color to a blue color) in a way similar to that for the above-described deformation ratio, as shown in FIG. 8, so that the corresponding client user who receives the clothes fitting service can visually perceive the clothes pressures occurring when the client user puts on the clothes.

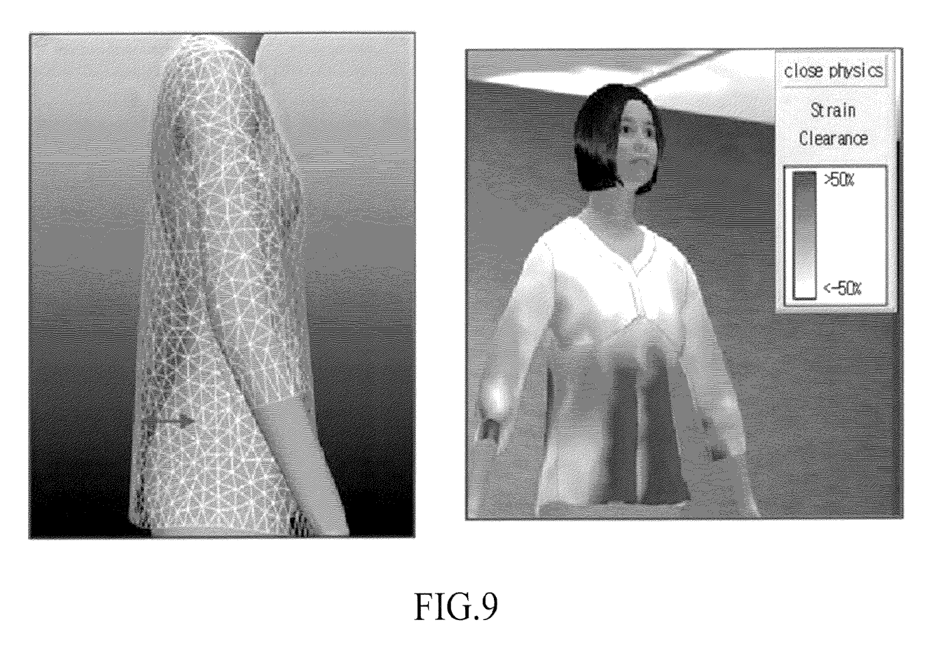

Furthermore, as shown in FIG. 9 as an example, the clothes business server 110 calculates the amount of space using a method of calculating the shortest distance from a point of fabric to the body of a 3D avatar in the direction vertical to the point of the fabric (a normal vector direction). The clothes business server 110 may represent the amount of space using partial variation in the color of clothes, for example, in such a way that the tone of a red color increases as the distance between a body and a fabric becomes longer and the tone of a white color increases as the distance between a body and fabric becomes shorter, in a way similar to that for the above-described clothes pressure, so that a client user who receives the clothes fitting service can visually perceive the amounts of space occurring when the client user puts on the clothes.

Next, a procedure of providing a clothes fitting service in which the clothes fitting service system having the above-described construction according the present invention is applied to the PPL technique will be described below.

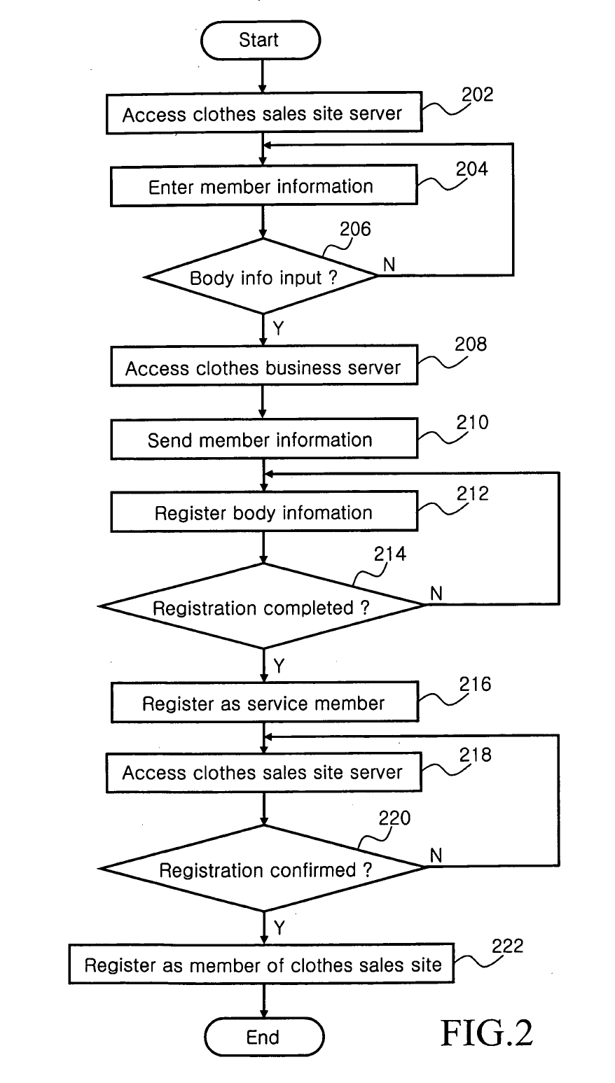

FIG. 2 is a flowchart showing a procedure of registering as a service member to receive a clothes fitting service in which the present invention is applied to the PPL technique.

Referring to FIG. 2, when a client who wants to registers with a specific clothes sales site server as a member accesses the corresponding clothes sales site server via the wireless communication network 106 and the network 108 or via the network 108, the corresponding clothes sales site server retrieves a main menu screen, including a member registration request item, and provides it to the corresponding client at step 202. As a result, the main menu screen is displayed on the monitor of the corresponding client.

Thereafter, when the corresponding client user enters personal information, such as example, a gender, a resident registration number, a mobile phone number, a mail address, and a residence address, as his or her member information at step 204 and selects the input of body information (for example, clicks on a body information input item) at step 206, the corresponding client is automatically enabled to access the clothes business server 110 at step 208. For example, when the body information input idem is clicked on, access to the linked clothes business server 110 can be automatically made. At the same time, the corresponding clothes sales site server sends the personal information of the corresponding client who wants to register as a member, such as a name, a gender, a resident registration number, and a mobile phone number, to the clothes business server 110 at step 210.

In response to this, the clothes business server 110 creates and retrieves a member registration page, that is, a member registration page in which the personal information received from the corresponding clothes sales site server is entered and the item of the selective input of body information is included, and provides it to the corresponding client via the network 108 and the wireless communication network 106 or via the network 108.

Accordingly, the corresponding client user can register (upload) body information, such as body information acquired through a 3D body scanner or the scan information of an actual photo, as his or her own body information. When the corresponding client user completes the registration of his or her own body information at steps 212 and 214, the clothes business server 110 classifies the corresponding client user as a member who belongs to the corresponding clothes sales site server, and registers the corresponding client user as a service member at step 216.

Thereafter, the corresponding client accesses the corresponding clothes sales site server again at step 218. For example, this may be constructed such that, when the corresponding client user clicks on a member registration completion item in the clothes business server, the corresponding client user automatically accesses a linked corresponding clothes sales site server (for example, provides notification of member registration). As a result, a member information input page provided by the corresponding clothes sales site server is displayed on the monitor of the corresponding client.

Thereafter, when the corresponding client user clicks on a member registration confirmation item in the member information input page at step 220, the corresponding clothes sales site server officially registers the corresponding client user as a member at step 222.

That is, in the present invention, using a method in which the clothes sales site server and the clothes business server are linked to each other and operate in conjunction with each as described above, a client user can register as the members of both the clothes sales site server and the clothes business server through a single access based on the manipulation of the client.

Meanwhile, although, in a preferred embodiment of the present invention, the description has been made of the case where corresponding personal information is used as member information in the clothes business server in such a way as to send the personal information, provided to the clothes sales site server by the client user to carry out member registration, from the clothes sales site server to the clothes business server, the present invention is not necessarily limited thereto. Personal information may not be sent from the clothes sales site server to the clothes business server, but a corresponding client user may directly input the personal information in a process of accessing the clothes business server to carry out member registration.

In contrast, although, in the preferred embodiment of the present invention, the description has been made of the case where the client user registers with both the clothes sales site server and the clothes business server as members and body information is registered as member information in the clothes business server, the present invention is not necessarily limited thereto, but setting may be made such that a user client can be registered only as a member in the clothes sales site server and receive a clothes fitting service. In this case, body information must be registered as member information in the clothes sales site server.

Next, a procedure of providing a clothes fitting service to respective clients who have registered as service members using the PPL technique according to the present invention through the above-described series of processes will be described.

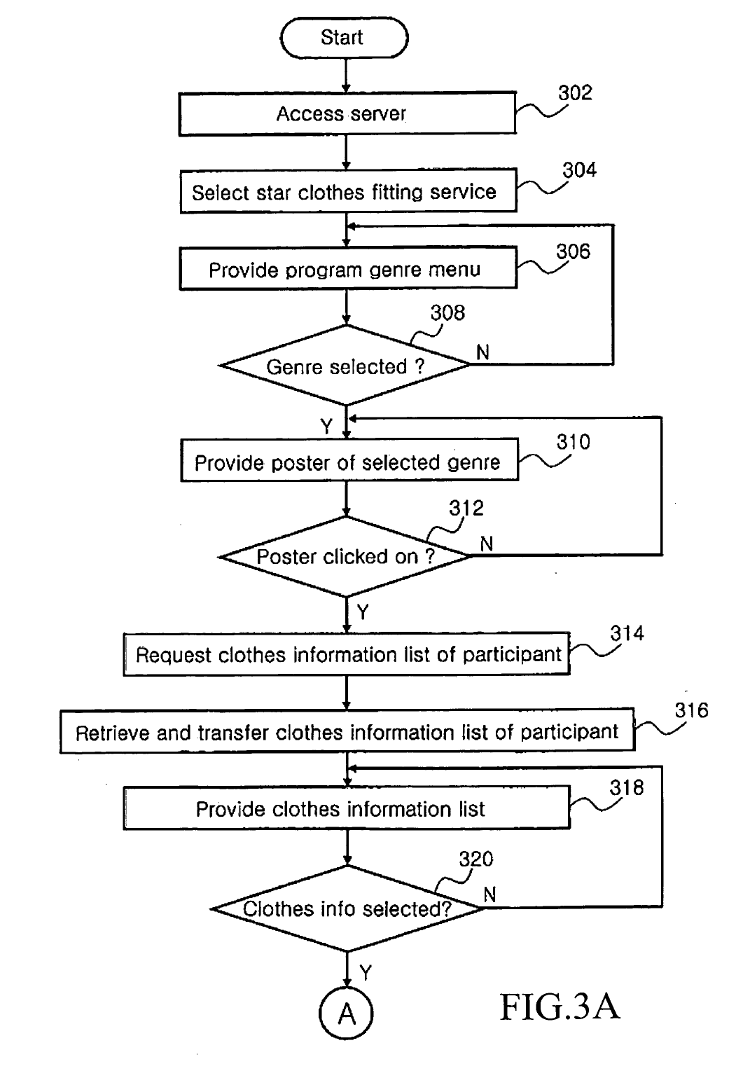

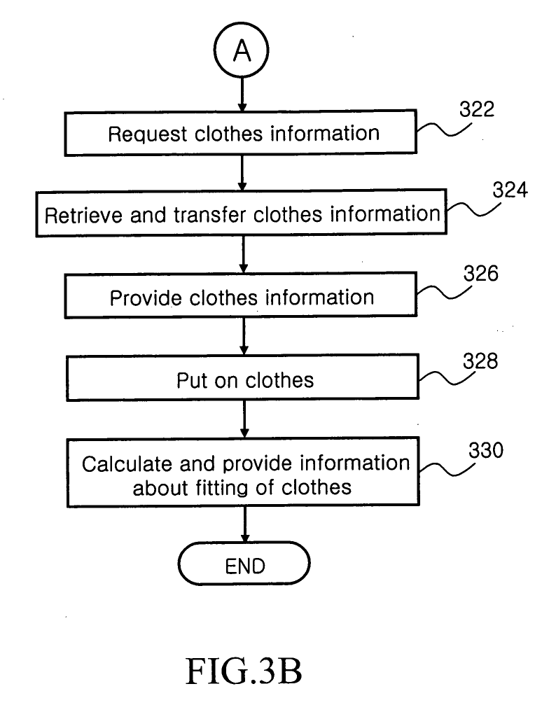

FIG. 3 is a flowchart showing a procedure of providing a clothes fitting service to clients through the application of the present invention to the PPL technique.

Referring FIG. 3, when a certain client who has registered as a service member accesses the clothes business server 110 via the wireless communication network 106 and the network 108 or via the network 108 and logs in, the clothes business server 110 retrieves a menu screen, including a “star clothes fitting service selection” item, and provides it to the corresponding client at step 302.

Thereafter, when the corresponding client user clicks on the star clothes fitting service selection item at step 304, the clothes business server 110 creates a genre menu screen, including information about a program genre, such as a movie, a drama, sports, comics, and an advertisement, and provides it to the corresponding client via the network 108 and the wireless communication network 106 or via the network 108 at step 306. Here, the program genre information is stored in the content DB 114, and is information that is updated with information frequently provided by respective clothes sales sites via the network 108.

Thereafter, when the corresponding client user selects a desired program genre in the genre menu screen at step 308, the clothes business server 110 retrieves the poster information of the selected program genre from the content DB 114 and provides the poster information to the corresponding client via the network 108 and the wireless communication network 106 or via the network 108 at step 310. As a result, the poster of the program genre selected by the user is displayed on the monitor of the corresponding client.

Thereafter, when the corresponding client user clicks on a poster being displayed on the monitor at step 312, the clothes business server 110 accesses the corresponding clothes sales site server via the network 108 and requests a clothes information list for the participants (for example, entertainers) of the corresponding poster at step 314, and the corresponding clothes sales site server searches its own content DB, retrieves a corresponding participant-related clothes information list, and sends the clothes information list to the clothes business server 110 via the network 108 in response to the request at step 316.

Thereafter, the clothes business server 110 provides the corresponding participant clothes information list, received from the corresponding clothes sales site server, to the corresponding client, and a clothes information list for the participants of a poster is displayed on the monitor of the corresponding client as a result at step 318.

Thereafter, when the corresponding client user clicks on desired clothes in the clothes information list at step 320, the clothes business server 110 accesses the corresponding clothes sales site server via the network 108 and requests information about clothes selected by the user (for example, clothes information composed of a still image, a moving image, etc.) at step 322, the corresponding clothes sales site server searches its own content DB and retrieves the requested clothes information in response to the request, and transfers the retrieved clothes information to the clothes business server 110 via the network 108 at step 324.

Thereafter, the clothes business server 110 provides the clothes information of the corresponding participants, received from the corresponding clothes sales site server, together with the 3D avatar of the corresponding client user, retrieved from the member DB 112, to the corresponding client, so that the clothes information of the participants and the 3D avatar are displayed on the monitor of the corresponding client at step 326. Here, the 3D avatar is a 3D avatar that is fabricated to be suitable for the client's own actual body characteristics using body information that has been registered as member information.

In this case, the corresponding client user can put the selected clothes on his or her own 3D avatar, or can receive a service of providing information about the fitting of clothes (or the adaptability of clothes) at step 328. For this purpose, the present invention provides a preview function that includes a posture-based view menu item and a motion-based view menu item.

That is, the posture-based view menu item is a menu option that causes a 3D avatar to put on corresponding clothes when a corresponding client user clicks on the corresponding item. Furthermore, a service of rotating the 3D avatar or magnifying the 3D avatar can be provided by selectively clicking on the 3D avatar while the 3D avatar puts on the clothes.

Furthermore, the motion-based view menu item is a menu option that causes a 3D avatar to put on selected clothes and be displayed on a dedicated motion viewer when a corresponding client user clicks on the corresponding item. A user can receive services related to playback, stop, and hyper view functions through motion control. Here, the hyper view function is a function of directing a scene in which a 3D avatar walks out of a screen.

Meanwhile, when the 3D avatar puts on the selected clothes based on the selection of the corresponding client user, the clothes business server 110 calculates information about the fitting of clothes, that is, the deformation ratio, the clothes pressure and the amount of space, which have been described in detail above, and the calculated information about the fitting of clothes is processed into color information for the 3D avatar and is then displayed on the monitor so that the corresponding client user can visually perceive the information about the fitting of clothes at step 330. For example, the information about the fitting of clothes may be represented using variation in color in such a way that the tone of a red color increases or decreases or the tone of a white color increases or decreases.

Accordingly, the corresponding client user can simply and easily check and determine whether selected clothes fit his or her body shape well in real time based on variation in the color of clothes that is put on a 3D avatar, which is displayed on a monitor.

Meanwhile, although, in the preferred embodiment of the present invention, the description has been made of the case where each clothes sales site server actually possesses (stores) a clothes information list and clothes information, and the clothes business server receives them from the corresponding clothes sales site server and provides them to a specific client when the corresponding client user requests a clothes fitting service, the present invention is not limited thereto, but the clothes business server may classify and possess (store) clothes information lists and clothes information for respective clothes sales sites.

In this case, when a clothes fitting service is provided to a client who requests the clothes fitting service, the clothes business server does not need to access a corresponding clothes sales site server and request desired information, so that another advantage can be expected in that communication traffic occurring when the clothes fitting service is provided can be considerably reduced. Meanwhile, in this case, setting can be made such that the clothes business server may provide only the results of the clothes fitting service (that is, the types of clothes that are put on for fitting, etc.), indicating that a specific client has received the clothes fitting service, together with the ID information of the corresponding client, to the corresponding clothes sales site server at an appropriate point of time (for example, at the time when the corresponding client logs out of the clothes business server). In this case, the reason that the results of the clothes fitting service are provided to the corresponding clothes sales site is that the corresponding clothes sales site server stores related information in its own member DB and uses the information as basic material for online marketing in the future. For this purpose, each clothes sales site server provides a related clothes information list and clothes information to the clothes business server via a network whenever a program genre-based poster is fabricated.

Meanwhile, although, in the preferred embodiment of the present invention, the description has been made of the case where the clothes business server possesses the body information of each member as member information, the present invention is not necessarily limited thereto, but setting can be made such that each clothes sales site server may possess body information. In this case, when the corresponding clothes sales site server retrieves clothes information from its own content DB and provides the clothes information to the clothes business server, the body information of a corresponding service member is provided along with the clothes information. Accordingly, the clothes business server creates the 3D avatar of the corresponding service member using body information that is provided along with the clothes information received from the clothes sales site server, and provides the created 3D avatar, along with the clothes information, to a corresponding client.

Next, a procedure in which a service member (a wireless or wired client) who receives a clothes fitting service through the above-described series of processes receives a clothes purchase service using the PPL technique online will be described below.

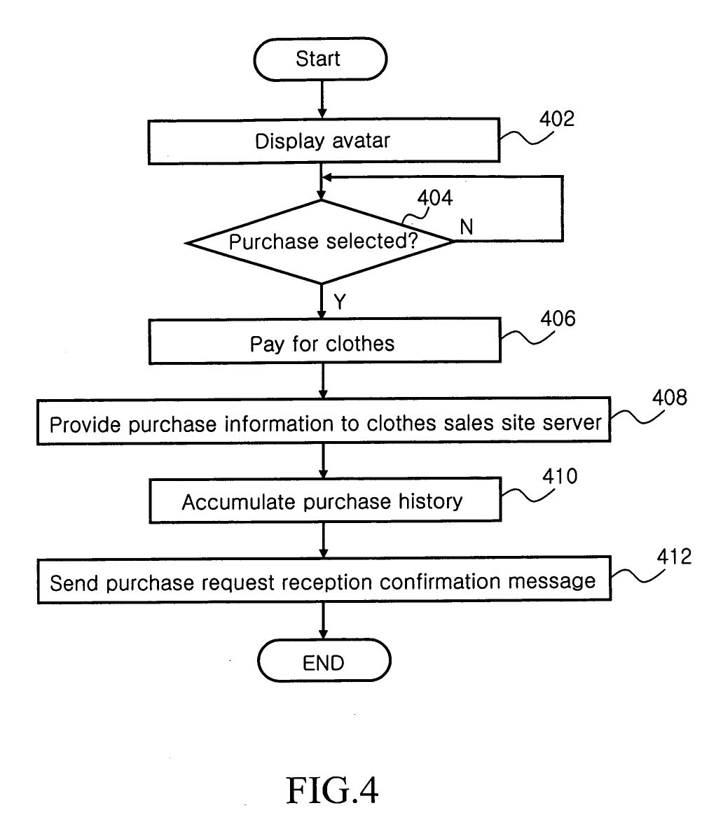

FIG. 4 is a flowchart showing a procedure that is carried out after the determination of a purchase by a client through the application of the present invention to the PPL technique.

Referring to FIG. 4, while a client user who has registered as a service member receives a 3D avatar, that is, the manifestation of the client user, and clothes information through a star clothes fitting service at step 402, the client user can receive a clothes purchase service for clothes selected by him or her. For example, the corresponding clothes can be purchased in such a way that, when a client user clicks on a purchase function for a 3D avatar who puts on the selected clothes, the message “Do you like clothes that you have tried?” is issued, and then when the corresponding client user selects “YES”, the client user is automatically moved to a payment web site and can make payment.

That is, when the corresponding service member client user selects a purchase of specific clothes at step 404, a screen is automatically changed to the screen of a payment web site. Thereafter, when the corresponding service member pays for the specific clothes at step 406, the clothes business server 110 sends purchase information (that is, purchaser information, purchased clothes information, etc.) to the corresponding clothes sales site server that sells the specific clothes purchased by the corresponding service member at step 408. In this case, the payment for the purchased clothes may be made through, for example, credit card payment, bank transfer, online money transfer, and cyber money payment.

In response to this, the corresponding clothes sales site server accumulates the purchase history of the corresponding member in the member DB at step 410, creates a purchase request reception confirmation message, including prearranged delivery date information, such as an Short Message Service (SMS) message, and sends it to the corresponding service member via the network 108 and the wireless communication network 106 or via the network 108 at step 412. Therefore, the corresponding service member can clearly confirm that the request for a purchase of clothes made by him or her has been received. In this case, the purchase request reception confirmation message is, for example, an SMS message, including information about the prearranged delivery date of the corresponding clothes, and the accumulated purchase history information may be used as information about the marketing of new products in the future.

Meanwhile, although, in the preferred embodiment of the present invention, the description has been made of the case where the clothes sales site server sends the purchase request reception confirmation message to the corresponding service member (a wireless or wired client), the present invention is not necessarily limited thereto. Accordingly, setting can be made such that the clothes business server sends the purchase request reception confirmation message, that is, when a corresponding service member selects a purchase of specific clothes, related purchase information is sent to a corresponding clothes sales site server, and a purchase request reception confirmation message is created and sent to the corresponding service member.

Furthermore, although, in the preferred embodiment of the present invention, the description has been made of the case where the clothes business server provides the clothes purchase service using the PPL technique, the present invention is not necessarily limited thereto. Accordingly, setting can be made such that each clothes sales site server directly provides a clothes purchase service, that is, when a service member selects a purchase of specific clothes online, the service member automatically accesses a clothes sales site server, which sells the corresponding clothes, rather than the clothes business server, so that each clothes sales site server can directly provide a clothes purchase service.

As described above, unlike the above-described prior art of providing a service of simply providing an actual photo of actual clothes or a service of enabling a user to put clothes on an avatar, that is, the manifestation of the user, the present invention realizes a service of creating an appropriate 3D avatar suitable for the body characteristics of the user based on body information registered as the member information of the service member, calculating information about the fitting of clothes, for example, the deformation ratio, the clothes pressure and the amount of space, when the selected clothes is put on his or her 3D avatar, and selectively providing the calculated information about the fitting of clothes to the service member, so that a high-quality online clothes fitting service can be provided to a large number of persons having various preferences for clothes and online clothes sales services can be considerably activated and promoted.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing a clothes fitting service to a plurality of clients having respective terminals, the terminals being capable of accessing a network via a wireless or wired connection, the method comprising:
receiving body information via the network, and creating a 3D user avatar corresponding to a client based on the body information;
allowing the client to select specific clothes;
providing the 3D user avatar with the selected specific clothes on; and
when the specific clothes are put on the 3D user avatar, calculating information about fitting of the clothes, and providing the calculated information about fitting of the clothes to the client.

2. The method as set forth in claim 1, wherein the calculated information about fitting of the clothes comprises deformation ratio information that indicates a degree of expansion of the clothes occurring when the clothes are put on the 3D user avatar.

3. The method as set forth in claim 1, wherein the calculated information about fitting of the clothes comprises clothes pressure information that indicates a degree of contact of the clothes with the 3D user avatar occurring when the clothes are put on the 3D user avatar.

4. The method as set forth in claim 1, wherein the calculated information about fitting of the clothes comprises information about an amount of space that indicates a space between a body of the 3D user avatar and the clothes occurring when the clothes are put on the 3D user avatar.

5. The method as set forth in claim 1, wherein the body information comprises at least one of body size information, hairstyle information, and actual photo information.

6. The method as set forth in claim 1, wherein the body information comprises at least one that is selected from among a plurality of gender-based representative body shapes, model faces, model bodies and model hairstyles, which were previously prepared.

7. The method as set forth in claim 1, wherein the calculated information about fitting of the clothes is represented through partial variation in color of the clothes that are put on the 3D user avatar.

8. The method as set forth in claim 1, further comprising:
the client requesting a purchase of the clothes that is put on the 3D user avatar; and
entrusting a seller of the corresponding clothes with the purchase of the clothes by transferring information about the request for a purchase of the clothes to the seller of the corresponding clothes.

9. The method as set forth in claim 8, further comprising adding information about the purchase of the clothes to previous purchase history information of the client, and storing resulting purchase history information.

10. The method as set forth in claim 8, further comprising creating a purchase request reception confirmation message in response to the request for the purchase, and sending the purchase request reception confirmation message to the client online.

11. The method as set forth in claim 1, wherein the selection of the clothes is performed by selecting a clothes from a provided clothes information list which is provided by selecting a poster of a participant displayed on a screen.
